(19) United States
(12) Patent Application Publication
(10) Pub. No.: US 2025/0015844 A1
(43) Pub. Date: Jan. 9, 2025

(54) METHOD AND APPARATUS FOR MULTIPLE-INPUT AND MULTIPLE-OUTPUT (MIMO) CHANNEL STATE INFORMATION (CSI) FEEDBACK

(71) Applicant: MEDIATEK INC., Hsinchu City (TW)

(72) Inventors: Gyu Bum KYUNG, San Jose, CA (US); Jiann-Ching GUEY, Hsinchu City (TW); Chia-Hao YU, Hsinchu City (TW)

(21) Appl. No.: 18/711,026

(22) PCT Filed: Feb. 28, 2023
(86) PCT No.: PCT/CN2023/078637

§ 371 Date: May 16, 2024

Related U.S. Application Data
(60) Provisional application No. 63/323,114, filed on Mar. 24, 2022.

(51) Int. Cl. H04B 7/0417; H04B 7/06; H04L 25/02

(52) U.S. Cl. CPC H04B 7/0417; H04B 7/0626; H04L 25/0254

(57) ABSTRACT

This disclosure provides a user equipment (UE) and methods for channel state information (CSI) compression. Processing circuitry of the UE obtain a plurality of first channel matrices that each indicates CSI of a communication channel between the UE and a respective one of multiple transmission-reception-points (TRPs). The processing circuitry compresses each of the plurality of first channel matrices into a respective feature vector through one or more convolutional neural networks (CNNs), and concatenates the plurality of feature vectors into a joint feature vector. The processing circuitry compresses the joint feature vector into a compressed joint feature vector through one or more fully connected neural networks (FCNNs).

### INCORPORATION BY REFERENCE

This present disclosure claims the benefit of U.S. Provisional Application No. 63/323,114, filed on Mar. 24, 2022, which is incorporated herein by reference in its entirety.

### TECHNICAL FIELD

The present disclosure relates to wireless communications, and specifically to a procedure for channel state information feedback between a transmitter and a receiver.

### BACKGROUND

In wireless communications, channel state information (CSI) can estimate channel properties of a communication link between a transmitter and a receiver. In related arts, the receiver can estimate the CSI of the communication link and feedback the raw CSI to a transmitter. This procedure can consume a great deal of communication resources and place a tremendous strain on a wireless network using modern multiple-input and multiple-output (MIMO) technology.

### SUMMARY

Aspects of the disclosure provide a method for channel state information (CSI) compression at a user equipment (UE). Under the method, a plurality of first channel matrices is obtained at the UE. Each first channel matrix indicates CSI of a communication channel between the UE and a respective one of multiple transmission-reception-points (TRPs). Each of the plurality of first channel matrices is compressed into a respective feature vector through one or more convolutional neural networks (CNNs). The plurality of feature vectors is concatenated into a joint feature vector. The joint feature vector is compressed into a compressed joint feature vector through one or more fully connected neural networks (FCNNs). The compressed joint feature vector is sent to each of the multiple TRPs for CSI feedback.

In an embodiment, a plurality of reference signals is received at the UE from the multiple TRPs. A plurality of second channel matrices is determined based on the plurality of reference signals. Each of the plurality of second channel matrices is transformed into a respective one of the plurality of first channel matrices.

In an embodiment, each of the plurality of second channel matrices is in a three dimensional domain that is represented by a transmit antenna index of one of the multiple TRPs, a time domain index, and a frequency domain index. Each of the plurality of first channel matrices is in a three dimensional domain that is represented by a transmit beam index of the one of the multiple TRPs, a delay component index, and a Doppler component index. Each of the one or more CNNs is a three dimensional CNN.

In an embodiment, each of the plurality of second channel matrices is in a four dimensional domain that is represented by a receive antenna index of the UE, a transmit antenna index of one of the multiple TRPs, a time domain index, and a frequency domain index. Each of the plurality of first channel matrices is in a four dimensional domain that is represented by a receive beam index of the UE, a transmit beam index of the one of the multiple TRPs, a delay component index, and a Doppler component index. Each of the one or more CNNs is a four dimensional CNN.

Aspects of the disclosure provide a UE. Processing circuitry of the UE obtains a plurality of first channel matrices that each indicates CSI of a communication channel between the UE and a respective one of multiple TRPs. The processing circuitry compresses each of the plurality of first channel matrices into a respective feature vector through one or more CNNs. The processing circuitry concatenates the plurality of feature vectors into a joint feature vector. The processing circuitry compresses the joint feature vector into a compressed joint feature vector through one or more FCNNs.

In an embodiment, receiving circuitry of the UE receives, from the multiple TRPs, a plurality of reference signals. The processing circuitry determines a plurality of second channel matrices based on the plurality of reference signals, and transforms each of the plurality of second channel matrices into a respective one of the plurality of first channel matrices.

In an embodiment, each of the plurality of second channel matrices is in a three dimensional domain that is represented by a transmit antenna index of one of the multiple TRPs, a time domain index, and a frequency domain index. Each of the plurality of first channel matrices is in a three dimensional domain that is represented by a transmit beam index of the one of the multiple TRPs, a delay component index, and a Doppler component index. Each of the one or more CNNs is a three dimensional CNN.

In an embodiment, each of the plurality of second channel matrices is in a four dimensional domain that is represented by a receive antenna index of the UE, a transmit antenna index of one of the multiple TRPs, a time domain index, and a frequency domain index. Each of the plurality of first channel matrices is in a four dimensional domain that is represented by a receive beam index of the UE, a transmit beam index of the one of the multiple TRPs, a delay component index, and a Doppler component index. Each of the one or more CNNs is a four dimensional CNN.

In an embodiment, transmitting circuitry of the UE sends, to each of the multiple TRPs, the compressed joint feature vector for CSI feedback.

Aspects of the disclosure provide a method for CSI decompression at a first TRP of multiple TRPs. Under the method, a compressed joint feature vector is received from a UE. The compressed joint feature vector is decompressed into a joint feature vector through one or more FCNNs. The joint feature vector includes multiple parts each corresponding to a respective one of the multiple TRPs, and a first part of the joint feature vector corresponds to the first TRP. The first part of the joint feature vector is decompressed into a channel matrix through one or more CNNs. CSI of a communication channel between the UE and the first TRP is determined based on the channel matrix.

In an embodiment, a reference signal is sent to the UE. The compressed joint feature vector is determined by the UE based on the reference signal.

In an embodiment, the channel matrix is in a three dimensional domain that is represented by a transmit beam index of the first TRP, a delay component index, and a Doppler component index. Each of the one or more CNNs is a three dimensional CNN.

In an embodiment, the channel matrix is in a four dimensional domain that is represented by a receive beam index of the UE, a transmit beam index of the first TRP, a delay component index, and a Doppler component index. Each of the one or more CNNs is a four dimensional CNN.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary procedure of CSI feedback according to embodiments of the disclosure;

FIG. 2 shows another exemplary procedure of CSI feedback according to embodiments of the disclosure;

FIG. 3A shows an exemplary CSI feedback according to embodiments of the disclosure;

FIG. 3B shows an exemplary MIMO CSI compression procedure according to embodiments of the disclosure;

FIG. 3C shows an exemplary MIMO CSI decompression procedure according to embodiments of the disclosure;

FIG. 4A shows an exemplary multi-TRP scheme according to embodiments of the disclosure;

FIG. 4B shows an exemplary MIMO CSI compression procedure according to embodiments of the disclosure;

FIG. 4C shows an exemplary MIMO CSI decompression procedure according to embodiments of the disclosure;

FIG. 5 shows an exemplary apparatus according to embodiments of the disclosure;

FIG. 6 shows a flowchart outlining a process according to embodiments of the disclosure;

FIG. 7 shows a flowchart outlining a process according to embodiments of the disclosure.

### DETAILED DESCRIPTION OF EMBODIMENTS

The detailed description set forth below in connection with the appended drawings is intended as a description of various configurations and is not intended to represent the only configurations in which the concepts described herein may be practiced. The detailed description includes specific details for the purpose of providing an understanding of various concepts. However, these concepts may be practiced without these specific details.

Several aspects of telecommunication systems will now be presented with reference to various apparatuses and methods. These apparatuses and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

In wireless communications, channel state information (CSI) can estimate channel properties of a communication link between a transmitter and a receiver. For example, CSI can describe how a signal propagates from the transmitter to the receiver, and represent a combined effect of phenomena such as scattering, fading, power loss with distance, and the like. Thus, CSI can also be referred to as channel estimation. CSI can make it feasible to adapt the transmission between the transmitter and the receiver to current channel conditions, and thus is a critical piece of information that needs to be shared between the transmitter and the receiver to allow high-quality signal reception.

In an example, the transmitter and the receiver (or transceivers) can rely on CSI to compute their transmit precoding and receive combining matrices, among other important parameters. Without CSI, a wireless link may suffer from a low signal quality and/or a high interference from other wireless links.

To estimate CSI, the transmitter can send a predefined signal to the receiver. That is, the predefined signal is known to both the transmitter and the receiver. The receiver can then apply various algorithms to perform CSI estimation. At this stage, CSI is known to the receiver only. The transmitter can rely on feedback from the receiver for acquiring CSI knowledge.

Raw CSI feedback, however, may require a large overhead which may degrade the overall system performance and cause a large delay. Thus, the raw CSI feedback is typically avoided.

Alternatively, from CSI, the receiver can extract some important or necessary information for the transmitter operations, such as precoding weights, rank indicator (RI), channel quality indicator (CQI), modulational and coding scheme (MCS), and the like. The extracted information can be much smaller than the raw CSI, and the receiver can only feedback these small pieces of information to the transmitter.

To further reduce the overhead, the receiver can estimate the CSI of the communication link and select a best transmit precoder from a predefined codebook of precoders based on the estimated CSI. Further, the receiver can feed information related to the selected best transmit precoder back to the transmitter, such as PMI from such a codebook. This procedure can consume a great deal of communication resources and place a tremendous strain on a wireless network using modern multiple-input and multiple-output (MIMO) technology.

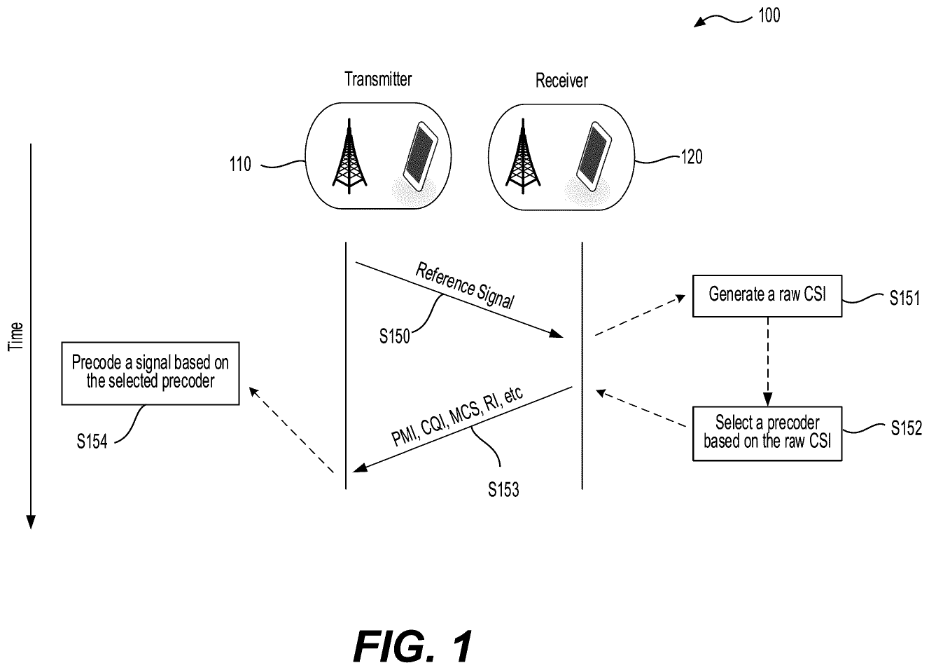

FIG. 1 shows an exemplary procedure 100 of CSI feedback according to embodiments of the disclosure. In the procedure 100, each of a transmitter 110 and a receiver 120 can be a user equipment (UE) or a base station (BS).

At step S150, the transmitter 110 can transmit a reference signal (RS) to the receiver 120. The RS is also known to the receiver 120 before the receiver 120 receives the RS. In an embodiment, the RS can be specifically intended to be used by devices to acquire CSI and thus is referred to as CSI-RS.

At step S151, after receiving the CSI-RS, the receiver 120 can generate a raw CSI by comparing the received CSI-RS with the transmitted CSI-RS that is already known to the receiver 120.

At step S152, the receiver 120 can select a best transmit precoder from a predefined codebook of precoders based on the raw CSI.

At step S153, the receiver 120 can send a PMI of the selected precoder back to the transmitter 110, along with relevant information such as CQI, RI, MCS, and the like.

At step S154, after receiving the PMI and the relevant information, the transmitter 110 can determine transmission parameters and precode a signal based on the selected precoder indicated by the PMI.

It is noted that a choice of the precoders is restricted to the predefined codebook in the procedure 100. However, restricting the choice of the precoders to the predefined codebook can limit the achievable system performance. Different precoder codebooks (e.g., 3GPP NR downlink Type I-Single Panel/Multi-Panel, Type II, eType II, or uplink codebook) have different preset feedback overheads. If the network specifies a preset codebook before the raw CSI is estimated at the receiver, the receiver is not able to further optimize the codebook selection based on tradeoffs between the feedback overhead and the system performance.

Aspects of this disclosure provide methods and embodiments to feedback a compressed version of raw CSI to a transmitter. Based on the compressed CSI, the transmitter is able to optimally compute a precoder for precoding a transmitting signal, and also optimally decide on other transmission parameters such as RI, MCS, and the like. Further, a compression ratio used in compressing the raw CSI can be decided dynamically after the raw CSI has been estimated, in order to allow an optimal tradeoff between the feedback overhead and the system performance.

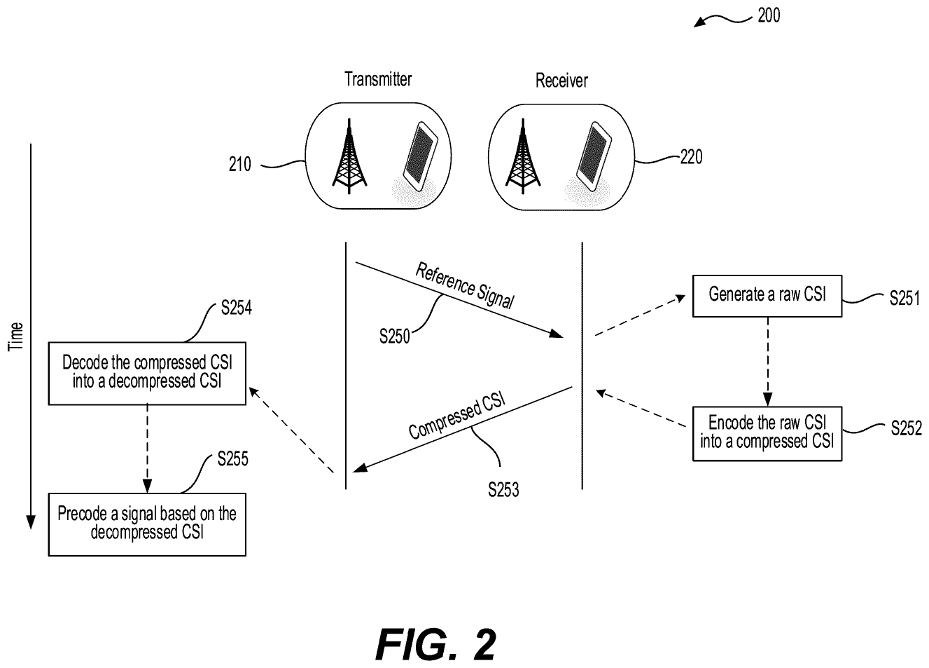

FIG. 2 shows an exemplary procedure 200 of CSI feedback according to embodiments of the disclosure. In the procedure 200, each of a transmitter 210 and a receiver 220 can be a user equipment (UE) or a base station (BS), and steps S250 and S251 are similar to steps S150 and S151 in the procedure 100 of FIG. 1, respectively.

At step S252, the receiver 220 can encode (or compress) the raw CSI into a compressed CSI.

At step S253, the receiver 220 can send the compressed CSI back to the transmitter 210.

At step S254, the transmitter 210 can decode (or decompress) the compressed CSI into a decompressed CSI.

At step S255, the transmitter 210 can determine transmission parameters and precode a signal based on the decompressed CSI.

According to aspects of the disclosure, a massive MIMO system can be used to increase downlink (DL) and/or uplink (UL) throughput between a transmitter and a receiver. However, downlink CSI feedback overhead can be significantly increased due to a large number of antennas at a BS. Accordingly, CSI compression can help to reduce the CSI feedback overhead.

An n_{R}×n_{T} MIMO channel in an orthogonal frequency-division multiplexing (OFDM) system can be expressed as a four dimensional (4D) channel matrix

$$H [ n , m ] = [ \begin{matrix}{h}_{11} [ n , m ] & … & {h}_{1 {n}_{T}} [ n , m ] \\ ⋮ & ⋱ & ⋮ \\ {h}_{{n}_{R} 1} [ n , m ] & … & {h}_{{n}_{R} {n}_{T}} [ n , m ]\end{matrix} ] ,$$

where n_{R} is a number of receive antennas (e.g., at UE) and n_{T} is a number of transmit antennas (e.g., at BS), n is a time domain index in the unit of OFDM symbol, and m is a frequency domain index in the unit of sub-carrier or sub-band. That is, the 4D channel matrix H [n, m] can be expressed in a 4D domain that is represented by a receive antenna index of the UE, a transmit antenna index of the BS, a time domain index, and a frequency domain index.

In an example, assuming n_{R}=1, then the MIMO channel can be expressed by a 3D matrix H_{3D}={h[i,n,m]: 1≤i≤n_{T}, 1≤n≤N, 1≤m≤M}, where N is a total number of OFDM symbols and M is a total number of sub-carriers or sub-bands. That is, the 3D matrix H_{3D} can be expressed in a 3D domain that is represented by a transmit antenna index of the BS, a time domain index, and a frequency domain index.

Further, H_{3D} can be transformed to a 3D domain that is represented by a beam component index, a delay component index, and a Doppler component index. The transformation can be performed by applying a 3D discrete Fourier transform (3D-DFT) on the 3D channel matrix H_{3D}. For example, let H̅_{3D} be the transformed channel matrix in the 3D domain that is represented by a beam component index, a delay component index, and a Doppler component index. That is, H̅_{3D}=3D-DFT (H_{3D})={h̅[j,k,l]: 1≤j≤n_{T}, 1≤k≤N, 1≤l≤M}, where j is a beam index, k is an index of Doppler components, and l is an index of delay components. In an example, if the beam component index and the delay component index are only considered, a 2D channel matrix can be obtained as H_{2D}={h[i,m]: 1≤i≤n_{T}, 1≤m≤M}, and a transformed matrix of the 2D channel matrix H_{2D} can be expressed as H̅_{2D}=2D-DFT (H_{2D})={h̅[j,l]: 1≤j≤n_{T}, 1≤l≤M}, by considering only one OFDM symbol.

According to aspects of the disclosure, various algorithms can be used for CSI compression, such as compressive sensing based CSI compression and deep learning (or machine learning) based CSI compression. Compared with the compressive sensing based CSI compression, the deep learning based solution can provide a better reconstruction performance, for example, in terms of mean squared error, at a base station.

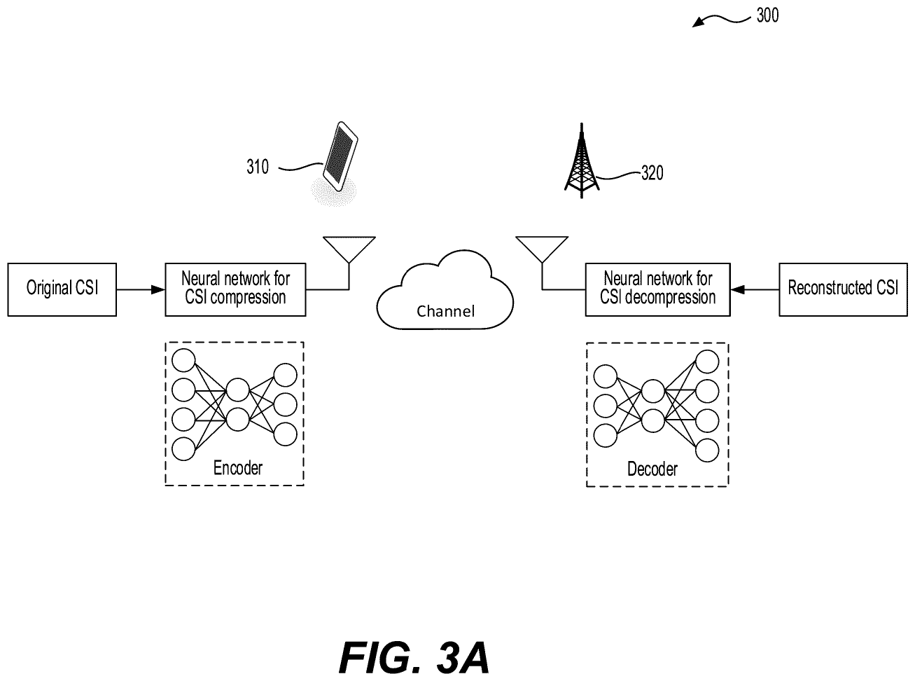

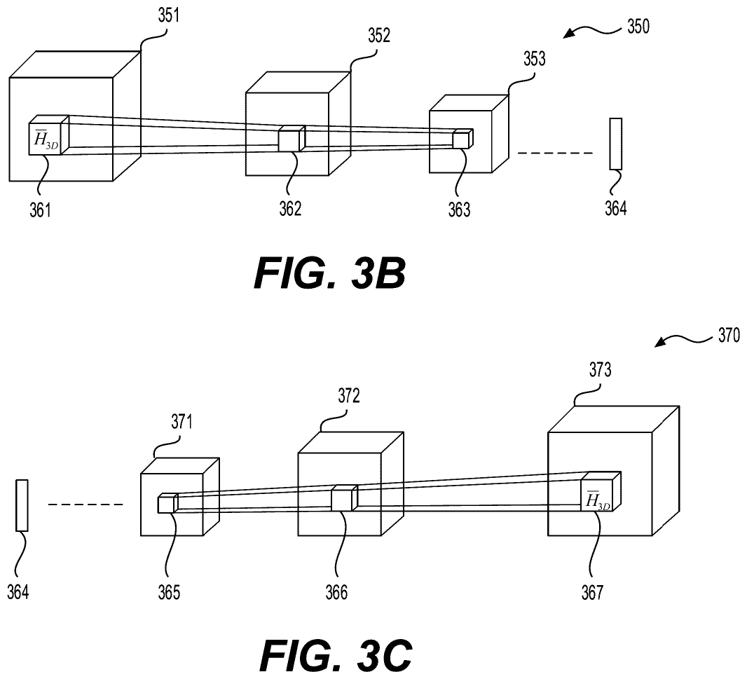

FIG. 3A shows an exemplary CSI feedback according to embodiments of the disclosure. In FIG. 3A, an encoder can use a neural network such as a deep neural network at a UE 310 to compress original CSI and a decoder can use a neural network such as a deep neural network at a BS 320 to decompress the compressed CSI and reconstruct the original CSI based on the decompressed CSI.

In some related arts, the CSI compression is only performed in a 2D domain that is represented by a beam component index and a delay component index, and thus the correlation in all physical domains such as antenna, time, and frequency are not fully utilized. In addition, CSI overhead can be increased for fast fading since frequent reports are required to avoid CSI aging problem.

Accordingly, this disclosure provides methods and embodiments for MIMO CSI compression and decompression.

FIG. 3B shows an exemplary MIMO CSI compression procedure 350 according to embodiments of the disclosure. In the MIMO CSI compression procedure 350, CSI of a communication channel between a UE and a BS can be expressed as a 3D channel matrix H̅_{3D} 361. The 3D channel matrix H̅_{3D} 361 can be expressed in a 3D domain that is represented by a transmit beam index of the BS, a delay component index, and a Doppler component index. At an encoder of the UE, the 3D channel matrix H̅_{3D} 361 can compressed into a compressed channel matrix through a plurality of 3D convolutional neural networks (CNNs) 351-353 so that a full feature of the 3D channel matrix H̅_{3D}361 can be extracted. Specifically, the channel matrix H̅_{3D} 361 can be compressed through a first 3D CNN 351 into a first compressed 3D matrix 362. The first compressed 3D matrix 362 can be further compressed through a second 3D CNN 352 into a second compressed 3D matrix 363, and so on. Through the CSI compression by using the plurality of 3D CNNs, an extracted feature vector 364 of the 3D channel matrix H̅_{3D} 361 can be obtained at the encoder and sent from the UE to the BS.

FIG. 3C shows an exemplary MIMO CSI decompression procedure 370 according to embodiments of the disclosure. In the MIMO CSI decompression procedure 370, the BS receives from the UE the extracted feature vector 364. At a decoder of the BS, the extracted feature vector 364 can be decompressed through a plurality of 3D CNNs 371-373. Specifically, the extracted feature vector 364 can be decompressed through a first 3D CNN 371 into a first decompressed 3D matrix 365. The first decompressed 3D matrix 365 can then be decompressed through a second 3D CNN 372 into a second decompressed 3D matrix 366, and so on. Through the CSI decompression by using the plurality of 3D CNNs 371-373, a reconstructed 3D channel matrix H̅_{3D} 367 can be obtained at the decoder of the BS to determine the CSI of the communication channel between the UE and the BS.

It is noted that a number of the 3D CNNs in the CSI compression procedure 350 (or in the CSI decompression procedure 370) is not limited and can be set according to various situations. In addition, the 3D CNNs in the CSI compression procedure 350 (or in the CSI decompression procedure 370) can be replaced with 4D CNNs if a 4D channel matrix is to be compressed (or decompressed). For example, if the number of receive antenna of the UE is greater than one, then the 4D channel matrix, instead of the 3D channel matrix, can be used at the encoder and decoder.

The CSI compression procedure 350 (or the CSI decompression procedure 370) can be applicable in a single TRP (transmission and reception point) scheme, in which the UE only communicates with a single serving TRP. In 3GPP NR (new radio) with a multiple-TRPs (multi-TRP) scheme, the UE can communicate with more than one TRP at the same time. The more than one TRP can be physically separated in different locations.

In an the single TRP scheme, when the UE is located near a cell edge, the path-loss from a serving TRP to the UE can be higher, and the interference from a neighboring TRP can also be higher. Accordingly, joint or coordinated transmission among the multiple TRPs in the multi-TRP scheme can increase spectral efficiency and reliability, for example, for blockage channel. Different TRPs may need various coding schemes and interference avoidance and/or cancellation schemes.

This disclosure provides methods and embodiments for MIMO CSI compression and decompression in the multi-TRP scheme.

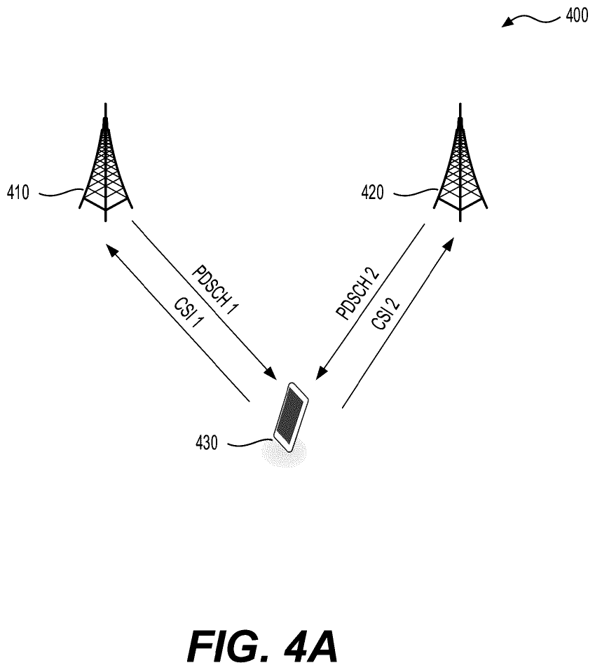

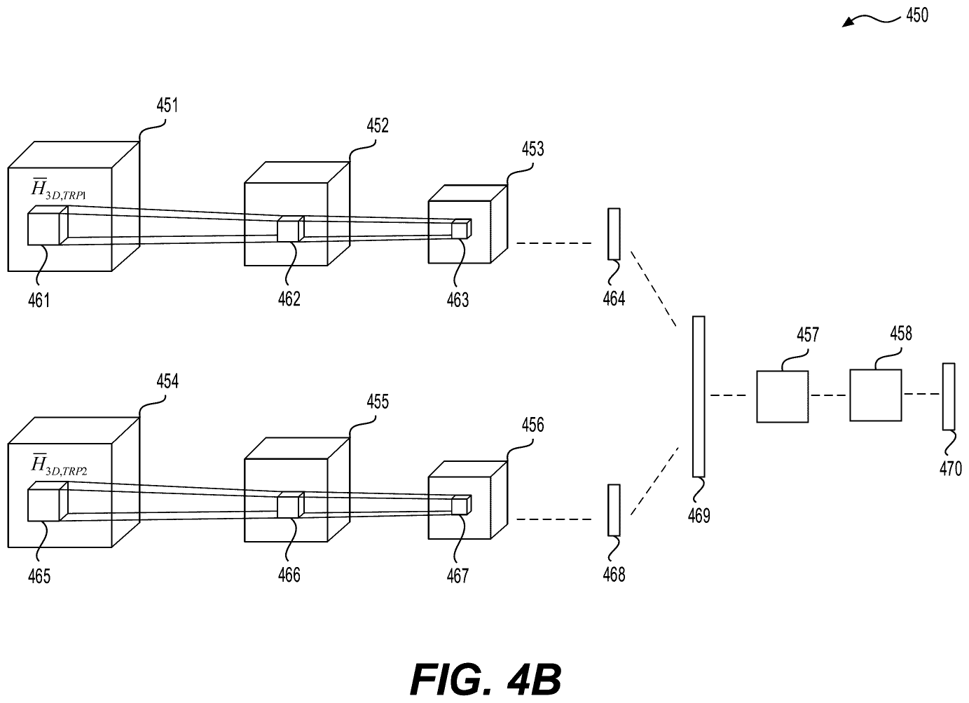

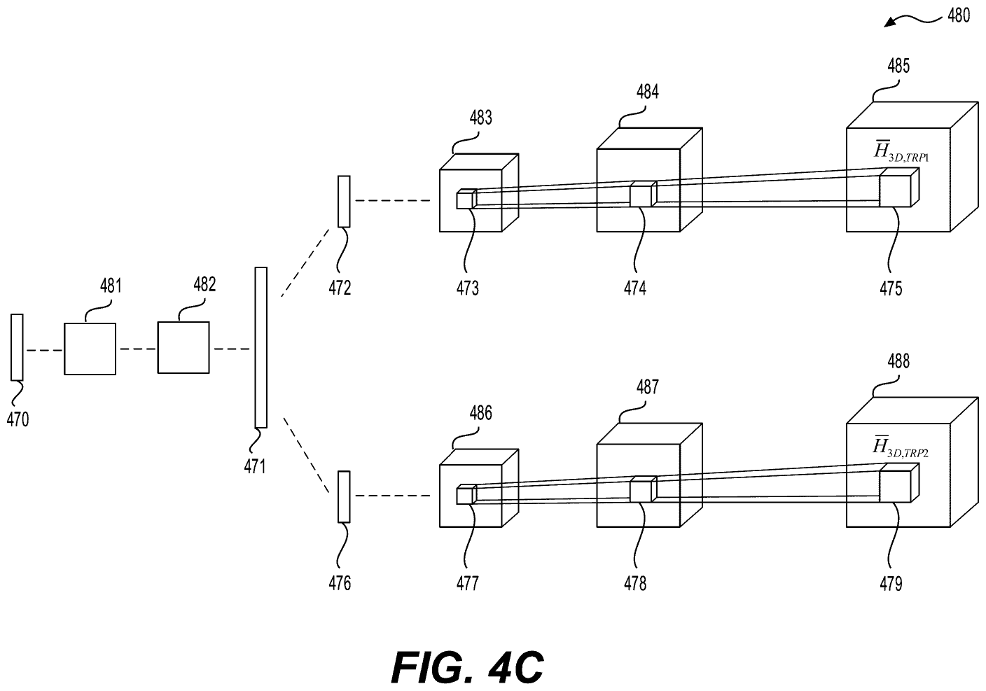

FIG. 4A shows an exemplary multi-TRP scheme according to embodiments of the disclosure. In FIG. 4A, a UE 430 can communicate with two TRPs 410 and 420 at the same time, for example, by receiving PDSCH (physical downlink shared channel) from each of the two TRPs 410 and 420, or by transmitting CSI to each of the two TRPs 410 and 420.

FIG. 4B shows an exemplary MIMO CSI compression procedure 450 according to embodiments of the disclosure. In the CSI compression procedure 450, a plurality of 3D channel matrices can be obtained at the UE 430. Each channel matrix can indicate CSI of a communication channel between the UE 430 and one of the multiple TRPs. For example, CSI of a communication channel between the UE 430 and the TRP 410 can be expressed as a first 3D channel matrix H̅_{3D,TRP1} 461, and CSI of a communication channel between the UE 430 and the TRP 420 can be expressed as a second 3D channel matrix H̅_{3D,TRP2} 465. Each 3D channel matrix can be expressed in a 3D domain that is represented by a transmit beam index of the corresponding TRP, a delay component index, and a Doppler component index.

At an encoder of the UE 430, each 3D channel matrix can compressed into a compressed channel matrix through a plurality of 3D convolutional neural networks (CNNs) so that a full feature of the respective 3D channel matrix can be extracted. For example, the first 3D channel matrix H̅_{3D,TRP1} 461 can be compressed into a first feature vector 464 through a first plurality of 3D CNNs 451-453. The second 3D channel matrix H̅_{3D,TRP2} 465 can be compressed into a second feature vector 468 through a second plurality of 3D CNNs 454-456.

The first and second feature vectors 464 and 468 can be concatenated into a joint feature vector 469. The joint feature vector 469 can be compressed into a compressed joint feature vector 470 through a plurality of fully connected neural networks (FCNNs) 457-458. The compressed joint feature vector 470 can be sent from the UE 430 to each of the two TRPs 410 and 420.

FIG. 4C shows an exemplary MIMO CSI decompression procedure 480 according to embodiments of the disclosure. In the CSI decompression procedure 450, the compressed joint feature vector 470 can be received by at least one of the two TRPs 410 and 420. The received compressed joint feature vector 470 can be decompressed into a joint feature vector 471 through a plurality of FCNNs 481-482. The joint feature vector 471 can be divided into two feature vectors 472 and 476. Each feature vector can be decompressed (or reconstructed) into a 3D channel matrix through a plurality of 3D CNNs, at a decoder of one of the multiple TRPs.

For example, at a decoder of the TRP 410, the first feature vector 472 can be decompressed into a first 3D channel matrix H̅_{3D,TRP1} 475 through a first plurality of 3D CNNs 483-485. The first 3D channel matrix H̅_{3D,TRP1} 475 can be used by the TRP 410 to determine CSI of a communication channel between the UE 430 and the TRP 410.

At a decoder of the TRP 420, the second feature vector 476 can be decompressed (or reconstructed) into a second 3D channel matrix H̅_{3D,TRP}2 479 through a second plurality of 3D CNNs 486-488. The second 3D channel matrix H̅_{3D,TRP}2 479 can be used by the TRP 420 to determine CSI of a communication channel between the UE 430 and the TRP 420.

It is noted that a number of the 3D CNNs (or the FCNNs) in the CSI compression procedure 450 (or in the CSI decompression procedure 480) is not limited and can be set according to various situations. In addition, the 3D CNNs in the CSI compression procedure 450 (or in the CSI decompression procedure 480) can be replaced with 4D CNNs if a 4D channel matrix is to be compressed (or decompressed). For example, if the number of receive antenna of the UE 430 is greater than one, then the 4D channel matrix, instead of the 3D channel matrix, can be used at the encoder and decoder.

It is noted that the MIMO channel matrix in this disclosure can be any variation of channel matrix such as precoder matrix or covariance matrix of channel.

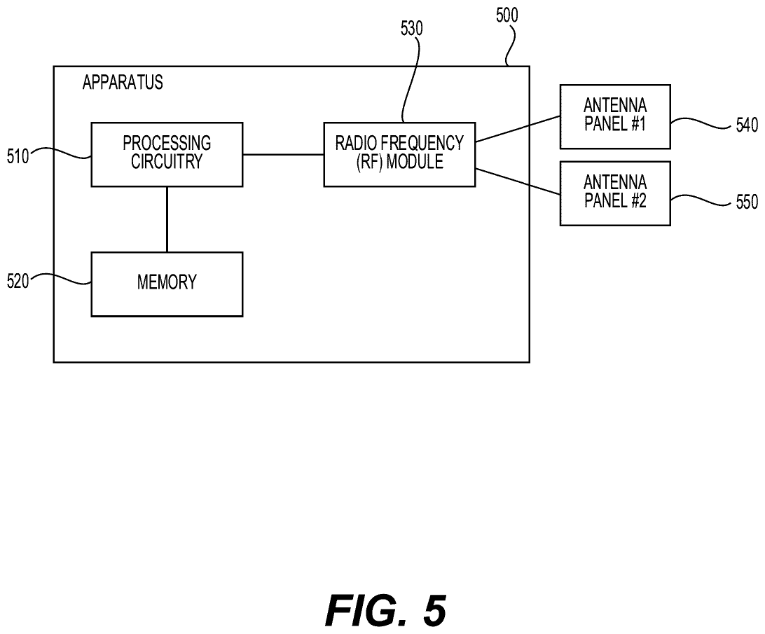

FIG. 5 shows an exemplary apparatus 500 according to embodiments of the disclosure. The apparatus 500 can be configured to perform various functions in accordance with one or more embodiments or examples described herein. Thus, the apparatus 500 can provide means for implementation of techniques, processes, functions, components, systems described herein. For example, the apparatus 500 can be used to implement functions of a UE or a base station (BS) (e.g., gNB) in various embodiments and examples described herein. The apparatus 500 can include a general purpose processor or specially designed circuits to implement various functions, components, or processes described herein in various embodiments. The apparatus 500 can include processing circuitry 510, a memory 520, and a radio frequency (RF) module 530.

In various examples, the processing circuitry 510 can include circuitry configured to perform the functions and processes described herein in combination with software or without software. In various examples, the processing circuitry 510 can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 510 can be a central processing unit (CPU) configured to execute program instructions to perform various functions and processes described herein. Accordingly, the memory 520 can be configured to store program instructions. The processing circuitry 510, when executing the program instructions, can perform the functions and processes. The memory 520 can further store other programs or data, such as operating systems, application programs, and the like. The memory 520 can include a read only memory (ROM), a random access memory (RAM), a flash memory, a solid state memory, a hard disk drive, an optical disk drive, and the like.

The RF module 530 receives a processed data signal from the processing circuitry 510 and converts the data signal to beamforming wireless signals that are then transmitted via antenna panels 540 and/or 550, or vice versa. The RF module 530 can include a digital to analog convertor (DAC), an analog to digital converter (ADC), a frequency up convertor, a frequency down converter, filters and amplifiers for reception and transmission operations. The RF module 530 can include multi-antenna circuitry for beamforming operations. For example, the multi-antenna circuitry can include an uplink spatial filter circuit, and a downlink spatial filter circuit for shifting analog signal phases or scaling analog signal amplitudes. Each of the antenna panels 540 and 550 can include one or more antenna arrays.

In an embodiment, part of all the antenna panels 540/550 and part or all functions of the RF module 530 are implemented as one or more TRPs (transmission and reception points), and the remaining functions of the apparatus 500 are implemented as a BS. Accordingly, the TRPs can be co-located with such a BS, or can be deployed away from the BS.

The apparatus 500 can optionally include other components, such as input and output devices, additional or signal processing circuitry, and the like. Accordingly, the apparatus 500 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid-state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

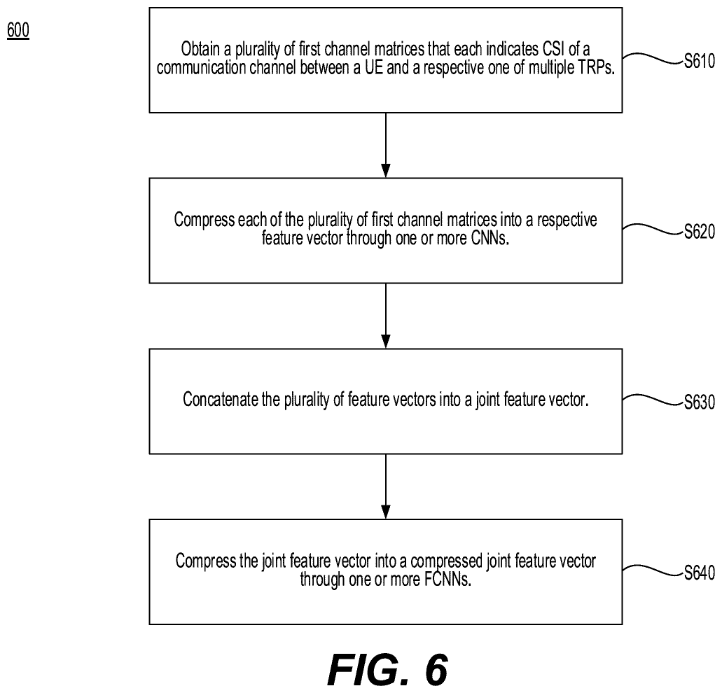

FIG. 6 shows a flowchart outlining a process 600 according to embodiments of the disclosure. The process 600 can be executed by the processing circuitry 510 of the apparatus 500. The process 600 may start at step S610.

At step S610, the process 600 obtains a plurality of first channel matrices that each indicates CSI of a communication channel between a UE and a respective one of multiple TRPs. Then, the process 600 proceeds to step S620.

At step S620, the process 600 compresses each of the plurality of first channel matrices into a respective feature vector through one or more CNNs. Then, the process 600 proceeds to step S630.

At step S630, the process 600 concatenates the plurality of feature vectors into a joint feature vector. Then, the process 600 proceeds to step S640.

At step S640, the process 600 compresses the joint feature vector into a compressed joint feature vector through one or more FCNNs. Then, the process 600 terminates.

In an embodiment, the process 600 sends, to each of the multiple TRPs, the compressed joint feature vector for CSI feedback.

According to aspects of the disclosure, the process 600 receives, from the multiple TRPs, a plurality of reference signals. Based on the plurality of reference signals, the process 600 determines a plurality of second channel matrices. The process 600 transforms each of the plurality of second channel matrices into a respective one of the plurality of first channel matrices.

In an embodiment, each of the plurality of second channel matrices is in a 3D domain that is represented by a transmit antenna index of one of the multiple TRPs, a time domain index, and a frequency domain index. Each of the plurality of first channel matrices is in a 3D domain that is represented by a transmit beam index of the one of the multiple TRPs, a delay component index, and a Doppler component index. Each of the one or more CNNs is a 3D CNN.

In an embodiment, each of the plurality of second channel matrices is in a 4D domain that is represented by a receive antenna index of the UE, a transmit antenna index of one of the multiple TRPs, a time domain index, and a frequency domain index. Each of the plurality of first channel matrices is in a 4D domain that is represented by a receive beam index of the UE, a transmit beam index of the one of the multiple TRPs, a delay component index, and a Doppler component index. Each of the one or more CNNs is a 4D CNN.

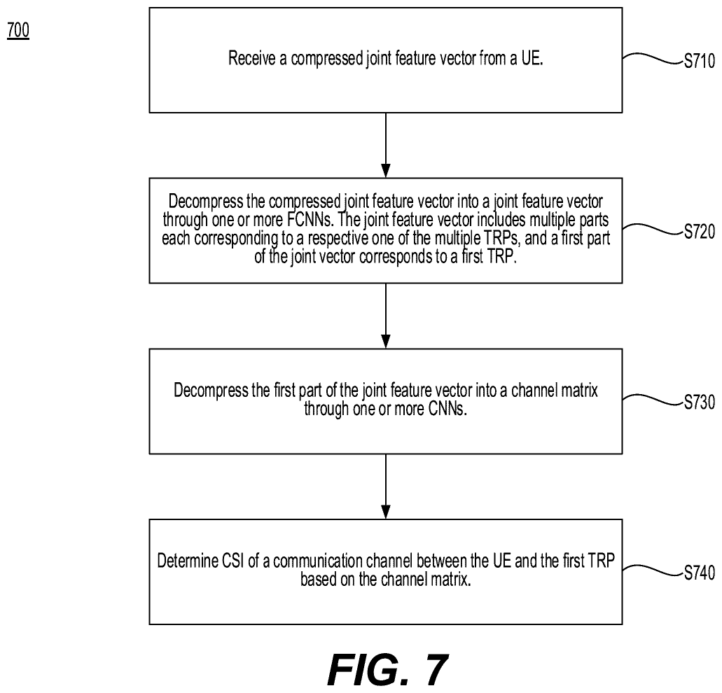

FIG. 7 shows a flowchart outlining a process 700 according to embodiments of the disclosure. The process 700 can be executed by the processing circuitry 510 of the apparatus 500. The process 700 may start from step S710.

At step S710, the process 700 receives a compressed joint feature vector from a UE. Then, the process 700 proceeds to step S720.

At step S720, the process 700 decompresses the compressed joint feature vector into a joint feature vector through one or more FCNNs. The joint feature vector includes multiple parts each corresponding to a respective one of the multiple TRPs, and a first part of the joint feature vector corresponds to a first TRP. Then, the process 700 proceeds to step S730.

At step S730, the process 700 decompresses the first part of the joint feature vector into a channel matrix through one or more CNNs. Then, the process 700 proceeds to step S740.

At step S740, the process 700 determines CSI of a communication channel between the UE and the first TRP based on the channel matrix. Then, the process 700 terminates.

In an embodiment, the process 700 sends a reference signal to the UE. The compressed joint feature vector is determined by the UE based on the reference signal.

In an embodiment, the channel matrix is in a 3D domain that is represented by a transmit beam index of the first TRP, a delay component index, and a Doppler component index. Each of the one or more CNNs is a 3D CNN.

In an embodiment, the channel matrix is in a 4D domain that is represented by a receive beam index of the UE, a transmit beam index of the first TRP, a delay component index, and a Doppler component index. Each of the one or more CNNs is a 4D CNN.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for”.

What is claimed is:

1. A method for channel state information (CSI) compression at a user equipment (UE), the method comprising:
obtaining a plurality of first channel matrices that each indicates CSI of a communication channel between the UE and a respective one of multiple transmission-reception-points (TRPs);
compressing each of the plurality of first channel matrices into a respective feature vector through one or more convolutional neural networks (CNNs);
concatenating the plurality of feature vectors into a joint feature vector; and
compressing the joint feature vector into a compressed joint feature vector through one or more fully connected neural networks (FCNNs).

2. The method of claim 1, further comprising:
receiving, from the multiple TRPs, a plurality of reference signals;
determining a plurality of second channel matrices based on the plurality of reference signals; and
transforming each of the plurality of second channel matrices into a respective one of the plurality of first channel matrices.

3. The method of claim 2, wherein each of the plurality of second channel matrices is in a three dimensional domain that is represented by a transmit antenna index of one of the multiple TRPs, a time domain index, and a frequency domain index, and each of the plurality of first channel matrices is in a three dimensional domain that is represented by a transmit beam index of the one of the multiple TRPs, a delay component index, and a Doppler component index.

4. The method of claim 3, wherein each of the one or more CNNs is a three dimensional CNN.

5. The method of claim 2, wherein each of the plurality of second channel matrices is in a four dimensional domain that is represented by a receive antenna index of the UE, a transmit antenna index of one of the multiple TRPs, a time domain index, and a frequency domain index, and each of the plurality of first channel matrices is in a four dimensional domain that is represented by a receive beam index of the UE, a transmit beam index of the one of the multiple TRPs, a delay component index, and a Doppler component index.

6. The method of claim 5, wherein each of the one or more CNNs is a four dimensional CNN.

7. The method of claim 1, further comprising:
sending, to each of the multiple TRPs, the compressed joint feature vector for CSI feedback.

8. A user equipment (UE), comprising:
processing circuitry configured to
obtain a plurality of first channel matrices that each indicates channel state information (CSI) of a communication channel between the UE and a respective one of multiple transmission-reception-points (TRPs);
compress each of the plurality of first channel matrices into a respective feature vector through one or more convolutional neural networks (CNNs);
concatenate the plurality of feature vectors into a joint feature vector; and
compress the joint feature vector into a compressed joint feature vector through one or more fully connected neural networks (FCNNs).

9. The UE of claim 8, further comprising:
receiving circuitry configured to
receiving, from the multiple TRPs, a plurality of reference signals,
wherein the processing circuitry is further configured to
determine a plurality of second channel matrices based on the plurality of reference signals, and
transform each of the plurality of second channel matrices into a respective one of the plurality of first channel matrices.

10. The UE of claim 9, wherein each of the plurality of second channel matrices is in a three dimensional domain that is represented by a transmit antenna index of one of the multiple TRPs, a time domain index, and a frequency domain index, and each of the plurality of first channel matrices is in a three dimensional domain that is represented by a transmit beam index of the one of the multiple TRPs, a delay component index, and a Doppler component index.

11. The UE of claim 10, wherein each of the one or more CNNs is a three dimensional CNN.

12. The UE of claim 9, wherein each of the plurality of second channel matrices is in a four dimensional domain that is represented by a receive antenna index of the UE, a transmit antenna index of one of the multiple TRPs, a time domain index, and a frequency domain index, and each of the plurality of first channel matrices is in a four dimensional domain that is represented by a receive beam index of the UE, a transmit beam index of the one of the multiple TRPs, a delay component index, and a Doppler component index.

13. The UE of claim 12, wherein each of the one or more CNNs is a four dimensional CNN.

14. The UE of claim 8, further comprising:
transmitting circuitry configured to
send, to each of the multiple TRPs, the compressed joint feature vector for CSI feedback.

15. A method for channel state information (CSI) decompression at a first transmission-reception-point (TRP) of multiple TRPs, the method comprising:
receiving a compressed joint feature vector from a user equipment (UE);
decompressing the compressed joint feature vector into a joint feature vector through one or more fully connected neural networks (FCNNs), the joint feature vector including multiple parts each corresponding to a respective one of the multiple TRPs, and a first part of the joint feature vector corresponding to the first TRP;
decompressing the first part of the joint feature vector into a channel matrix through one or more convolutional neural networks (CNNs); and
determining CSI of a communication channel between the UE and the first TRP based on the channel matrix.

16. The method of claim 15, further comprising:
sending a reference signal to the UE, wherein the compressed joint feature vector is determined by the UE based on the reference signal.

17. The method of claim 15, wherein the channel matrix is in a three dimensional domain that is represented by a transmit beam index of the first TRP, a delay component index, and a Doppler component index.

18. The method of claim 17, wherein each of the one or more CNNs is a three dimensional CNN.

19. The method of claim 15, wherein the channel matrix is in a four dimensional domain that is represented by a receive beam index of the UE, a transmit beam index of the first TRP, a delay component index, and a Doppler component index.

20. The method of claim 19, wherein each of the one or more CNNs is a four dimensional CNN.
